(19) United States
(12) Patent Application Publication
(10) Pub. No.: US 2016/0028453 A1
(43) Pub. Date: Jan. 28, 2016

(54) OFDM COMMUNICATION SYSTEM, METHOD AND DEVICE FOR TRANSCEIVING SIGNAL

(71) Applicant: SPREADTRUM COMMUNICATIONS (SHANGHAI) CO., LTD., Shanghai (CN)

(72) Inventors: Yongfang Zhou, Shanghai (CN); Fajun Yan, Shanghai (CN); Xiaojian Dong, Shanghai (CN)

(73) Assignee: SPREADTRUM COMMUNICATIONS (SHANGHAI) CO., LTD., Shanghai (CN)

(21) Appl. No.: 14/432,469

(22) PCT Filed: Dec. 31, 2013
(86) PCT No.: PCT/CN2013/091125

§ 371 Date: Mar. 30, 2015

(51) Int. Cl. H04B 7/04; H04L 5/00

(52) U.S. Cl. CPC H04B 7/0456; H04L 5/0007

(57) ABSTRACT

An OFDM communication system, a method and a device for transceiving signal are provided. The method includes: dividing M transmitting antennas into one or more groups to form U transmitting ports, wherein transmitting antennas in different groups are uncorrelated, and M is greater than or equal to U; forming P data flows using a Multiple-Input Multiple-Output (MIMO) mode, wherein P=U/2, and P is less than or equal to a number of receiving ports; and mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports. The data transmission performance can be improved.

### CROSS-REFERENCE TO RELATED APPLICATIONS

The present application is a Section National Stage Application of International Application No. PCT/CN2013/091125, filed on Dec. 31, 2013, and entitled “OFDM COMMUNICATION SYSTEM, METHOD AND DEVICE FOR TRANSCEIVING SIGNAL”, the entire disclosure of which is incorporated herein by reference.

### TECHNICAL FIELD

The present disclosure generally relates to communication technology, and more particularly, to an OFDM communication system, a method and a system for transceiving signal.

### BACKGROUND

Orthogonal Frequency Division Multiplexing (OFDM) technology effectively improves spectrum utilization by utilizing orthogonal properties between subcarriers and allowing the subcarriers to overlap each other. Duration of data symbols on each subcarrier is greatly increased through a serial-parallel conversion of data flow, and Inter Symbol Interference (ISI) is effectively reduced by adding a cyclic prefix. Because each subcarrier has a narrow bandwidth, equalization operation can be performed on each subcarrier, which reduces complexity of receivers. OFDM technology has been widely used in Long Term Evolution (LTE) systems and WLAN systems.

In current development of wireless communication technology, as user number is rapidly increasing, the most important target of wireless communication technology is to increase system capacity and data transfer rate, so as to improve user experience. For these objectives, multi-antenna technologies have become a mainstream, among which Multiple-Input Multiple-Output (MIMO) technology is one of the major applications.

In MIMO, a plurality of transmitting antennas and a plurality of receiving antennas are respectively used as a transmitting end and a receiving end. Its basic idea is that, multi-antennas are respectively used at the transmitting end and the receiving end to improve spectrum utilization, communication quality and system capacity by using space-time processing technology to make full use of independent characteristics between the channels. The MIMO technology makes full use of the independent wireless channels between the transmitting end and the receiving end. At the receiving end, the plurality of different data flows transmitted from the transmitting antennas seems to have distinguishable spatial characteristics. Therefore, a combined MIMO channel between the transmitting end and the receiving end can be recognized as including N (N represents the smaller one of the antenna numbers at the transmitting and receiving ends) parallel sub-channels, and the capacity of the MIMO channel equals to a sum of capacities of the N sub-channels.

In a conventional MIMO-OFDM communication system, both the OFDM technology and the MIMO technology are used to improve spectrum utilization, reduce equalization complexity of receiver and improve the transmission rate of the system.

MIMO leads to a result that, a plurality of antennas simultaneously transmits a plurality of data flows on a single physical resource unit, and correspondingly, a plurality of antennas receive these data flows at the receiving end, so as to improve data transmission efficiency on the physical resource unit. In an OFDM system, each single physic resource unit is called a Resource Element (RE). The MIMO technology may multiplex N modulation symbols on a resource element, where N represents the number of data flows, which is greater than or equal to 2. Therefore, the spectrum efficiency can be multiplied by N times. N is determined by the number of antennas or ports at the transmitting end and the receiving end. The number of antennas or ports at both the transmitting end and the receiving end must be greater than or equal to N. The “Large delay CDD scheme” transmission mode, the “Closed-loop spatial multiplexing scheme” transmission mode and the “Dual layer scheme” transmission mode described in the standards of 3GPP TS 36.211 and 3GPP TS 36.123 are typical applications of MIMO technology in LTE system.

As we know, a high Signal to Noise Ratio (SNR) is needed in MIMO transmission. However, because there are interferences between the plurality of data flows, Block Error Ratio (BLER) decreases slowly as the SNR increases, which may affect data transmission rate.

### SUMMARY

The present disclosure aims to solve the problem that BLER decreases slowly as the SNR increases, which affect data transmission rate in the conventional technology.

A signal transmitting method for Orthogonal Frequency Division Multiplexing (OFDM) communication system is provided in embodiments of the present disclosure. The method includes:

dividing M transmitting antennas into one or more groups to form U transmitting ports, wherein transmitting antennas in different groups are uncorrelated, and M is greater than or equal to U;

forming P data flows using a Multiple-Input Multiple-Output (MIMO) mode, wherein P=U/2, and P is less than or equal to a number of receiving ports; and

mapping a group of 2P modulation symbols, including two modulation symbols of each data flow, to a resource element pair to form Space Frequency Block Code (SFBC) coding relationships with each other, and transmitting the SFBC coding relationships on the U transmitting ports.

In some embodiments, the one or more groups of transmitting antennas formed by dividing the M transmitting antennas constitute diversity antennas, one group or more than one group of antenna arrays.

In some embodiments, each group of transmitting antennas constitutes an antenna array, and forms one or more transmitting ports based on one or more pre-coding weights or one or more beam weights, where the number of the pre-coding weights or the number of the beam weights is equal to the number of the transmitting ports.

In some embodiments, U=4, P=2, the M transmitting antennas are divided into four groups, and the four groups of transmitting antennas constitute diversity antennas; and

mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports includes: a first group of transmitting antennas transmitting, in a single antenna mode or a single port mode, a modulation symbol s₁₁ on a first resource element and a modulation symbol s*₁₂ on a second resource element;

a second group of transmitting antennas transmitting, in a single antenna mode or a single port mode, a modulation symbol s₂₁ on a first resource element and a modulation symbol s*₂₂ on a second resource element;

a third group of transmitting antennas transmitting, in a single antenna mode or a single port mode, a modulation symbol s₁₂ on the first resource element and a modulation symbol −s*₁₁ on the second resource element; and

a fourth group of transmitting antennas transmitting, in a single antenna mode or a single port mode, a modulation symbol s₂₂ on the first resource element and a modulation symbol −s*₂₁ on the second resource element,

wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

In some embodiments, if any group of transmitting antennas comprises more than one transmitting antennas, the transmitting antennas in that group form a single port based on one group of pre-coding weights or beam weights and transmit in an antenna array mode.

In some embodiments, U=4, P=2, the M transmitting antennas are divided into two groups to form antenna arrays respectively, and each group of transmitting antennas uses two groups of pre-coding weights or beam weights to form two transmitting ports; and

mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports include:

the first group of transmitting antennas using a first transmitting port thereof to transmit a modulation symbol s₁₁ on a first resource element, and transmit a modulation symbol s*₁₂ on a second resource element, and the first group of transmitting antennas using a second transmitting port thereof to transmit a modulation symbol s₂₁ on the first resource element, and transmit a modulation symbol s*₂₂ on the second resource element; and

the second group of transmitting antennas using a first transmitting port thereof to transmit a modulation symbol s₁₂ on the first resource element, and transmit the modulation symbol −s*₁₁ on the second resource element, and the second group of transmitting antennas using a second transmitting port thereof to transmit a modulation symbol s₂₂ on the first resource element, and transmit a modulation symbol −s*₂₁ on the second resource element,

wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

In some embodiments, U=4, P=2, the M transmitting antennas are divided to form one group of transmitting antennas which constitute an antenna array, and the antenna array forms four transmitting ports based on four groups of pre-coding weights or beam weights; and

mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports comprise:

a first transmitting port transmitting a modulation symbol s₁₁ on a first resource element, and transmitting a modulation symbol s*₁₂ on a second resource element;

a second transmitting port transmitting a modulation symbol s₂₁ on the first resource element, and transmitting a modulation symbol s*₂₂ on the second resource element;

a third transmitting port transmitting a modulation symbol s₁₂ on the first resource element, and transmitting a modulation symbol −s*₁₁ on the second resource element; and

a fourth transmitting port transmitting a modulation symbol s₂₂ on the first resource element, and transmitting a modulation symbol −s*₂₁ on the second resource element,

wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

In some embodiments, the pre-coding weights or the beam weights are obtained based on a codebook or an estimation of uplink channels.

In some embodiments, a method for obtaining the pre-coding weights or the beam weights based on an estimation of uplink channels includes:

performing a channel estimation in frequency domain based on a pilot signal transmitted from an receiving end;

converting a result of the channel estimation into time domain and estimating Direction Of Arrival (DOA) values of a plurality of resolvable paths in time domain; and

selecting DOA values corresponding to R strongest paths for each group of transmitting antennas and generating corresponding direction vectors as the pre-coding weights or the beam weights, wherein R is determined by a number of the groups of the transmitting antennas.

In some embodiments, the method further includes: allocating U pilot signals configured by the system to the U transmitting ports respectively.

In some embodiments, the OFDM communication system is an LTE system.

In order to solve above problems, a signal transmitting device for Orthogonal Frequency Division Multiplexing (OFDM) communication system is also provided in embodiments of the present disclosure. The device includes:

a first grouping unit, adapted for dividing M transmitting antennas into one or more groups to form U transmitting ports, wherein transmitting antennas in different groups are uncorrelated, and M is greater than or equal to U;

a Multiple Input Multiple Output (MIMO) unit, adapted for forming P data flows using a MIMO mode, wherein P=U/2, and P is less than or equal to a number of receiving ports; and

a mapping unit, adapted for mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports.

In order to solve above problems, a signal receiving method for Orthogonal Frequency Division Multiplexing (OFDM) communication system is also provided in embodiments of the present disclosure. The method includes:

dividing Q receiving antennas into S groups, wherein each group of receiving antennas corresponds to a receiving port, receiving antennas in different groups are uncorrelated, Q is greater than or equal to 2, and S is greater than or equal to 2; and

receiving signals transmitted by the signal transmitting method described above through each receiving port, and detaching modulation symbols of each data flow mapped to the resource element pair.

In some embodiments, detaching modulation symbols of each data flow mapped to the resource element pair includes:

obtaining channel estimation values of pilot signals transmitted from the U transmitting ports and received at each receiving port;

forming a combined transmission equation based on the channel estimation values and the received modulation symbols mapped to the resource element pair; and

solving the combined transmission equation to detach each modulation symbol.

In some embodiments, U=4, and S=2;

signals r_{pq} the two receiving antennas received on the resource element pair are represented by:

r₁₁=w₁₁h₁₁s₁₁+w₁₂h₁₂s₂₁+w₂₁h₁₃s₁₂+w₂₂h₁₄s₂₂;

r₁₂=w₁₁h₁₁s*₁₂+w₁₂h₁₂s*₂₂−w₂₁h₁₃s*₁₁−w₂₂h₁₄s*₂₁;

r₂₁=w₁₁h₂₁s₁₁+w₁₂h₂₂s₂₁+w₂₁h₂₃s₁₂+w₂₂h₂₄s₂₂;

r₂₂=w₁₁h₂₁s*₁₂+w₁₂h₂₂s*₂₂−w₂₁h₂₃s*₁₁−w₂₂h₂₄s*₂₁;

p=1, 2 represents receiving port number, and q=1, 2 represents resource element number;

s₁₁, s₁₂, s₂₁ and s₂₂ are modulation symbols of each data flow mapped to the resource element pair, the modulation symbol −s*₁₁ is a negative conjugated form of the modulation symbol s₁₁, the modulation symbol s*₁₂ is a conjugated form of the modulation symbol s₁₂, the modulation symbol −s*₂₁ is a negative conjugated form of the modulation symbol s₂₁, and the modulation symbol s*₂₂ is a conjugated form of the modulation symbol s₂₂;

\tilde{h}₁₁, \tilde{h}₁₂, \tilde{h}₁₃, \tilde{h}₁₄ represent channel estimation values of pilot signals transmitted from the four transmitting ports and received at the first receiving antenna, where \tilde{h}₁₁=W₁₁h₁₁, \tilde{h}₁₂=W₁₂h₁₂, \tilde{h}₁₃=W₂₁h₁₃, \tilde{h}₁₄=W₂₂h₁₄;

\tilde{h}₂₁, \tilde{h}₂₂, \tilde{h}₂₃, \tilde{h}₂₄ represent channel estimation values of pilot signals transmitted from the four transmitting ports and received at the second receiving antenna, where \tilde{h}₂₁=W₁₁h₂₁, \tilde{h}₂₂=W₁₂h₂₂, \tilde{h}₂₃=W₂₁h₂₃, \tilde{h}₂₄=W₂₂h₂₄;

Wᵢⱼ represents the transmission pre-coding weights or beam weights of the four transmitting ports, where i=1, 2 represents a transmitting port number of the j^{th} data flow, j=1, 2 represents a sequence number of the data flow, h_{xy} represents fading channels of signals transmitted from the four transmitting ports to the receiving ports, x=1, 2 corresponds to a receiving port number, and y=1, 2, 3, 4 corresponds to a transmitting port number; and

the combined transmission equation is represented by:

$$[ \begin{matrix}{r}_{11} \\ {r}_{12}^{*} \\ {r}_{21} \\ {r}_{22}^{*}\end{matrix} ] = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] [ \begin{matrix}{s}_{11} \\ {s}_{12} \\ {s}_{21} \\ {s}_{22}\end{matrix} ] .$$

In some embodiments, a Minimum Mean Square Error (MMSE) estimation method is used to solve the combined transmission equation through an equation shown below, so as to obtain each modulation symbol:

$$[ \begin{matrix}{\hat{s}}_{11} \\ {\hat{s}}_{12} \\ {\hat{s}}_{21} \\ {\hat{s}}_{22}\end{matrix} ] = {( {H}^{H} H + {R}_{n} )}^{- 1} {H}^{H} [ \begin{matrix}{r}_{11} \\ {r}_{12}^{*} \\ {r}_{21} \\ {r}_{22}^{*}\end{matrix} ] ;$$

where ŝ₁₁, ŝ₁₂, ŝ₂₁ and ŝ₂₂ represent resolved modulation symbols, Rₙ is a matrix related to noise estimation, and

$$H = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] .$$

In order to solve above problems, a signal receiving device for Orthogonal Frequency Division Multiplexing (OFDM) communication system is also provided in embodiments of the present disclosure. The device includes:

a second grouping unit, adapted for dividing Q receiving antennas into S groups, wherein each group of receiving antennas corresponds to a receiving port, receiving antennas in different groups are uncorrelated, Q is greater than or equal to 2, and S is greater than or equal to 2; and

a receiving unit, adapted for receiving signals transmitted by the signal transmitting device described above through each receiving port; and

a detaching unit, adapted for detaching modulation symbols of each data flow mapped to the resource element pair.

In order to solve above problems, an Orthogonal Frequency Division Multiplexing (OFDM) communication system is also provided in embodiments of the present disclosure. The system includes the above signal transmitting device and the above signal receiving device.

Compared with the conventional technology, embodiments of the present disclosure have following advantages.

By combining the MIMO technology and the SFBC technology, P data flows of MIMO are transmitted in an SFBC mode (P is determined by a number of the transmitting ports and a number of the receiving ports). Specifically, a group of 2P modulation symbols constituted by two modulation symbols of each data flow are mapped to a resource element pair to form SFBC coding relationships, and then the group of 2P modulation symbols are transmitted on U transmitting ports obtained by dividing the M transmitting antennas. Therefore, high spectral efficiency of MIMO is inherited, and transmission accuracy of MIMO is improved by using diversity gain of SFBC. The problem of the slow decrease of BLER in the MIMO transmission is solved, the data transmission rate is improved, and transmission performance of the system is improved.

Particularly, when multiple antennas are configured at the transmitting end and only two antennas are configured at the receiving end for cost reasons, embodiments of the present disclosure can improve data transmission rate and user experience effectively without increasing costs.

By dividing the M transmitting antennas to form two groups of antenna arrays or one group of antenna array for beam-forming transmission, the demodulation performance of the MIMO+SFBC manner is improved because instantaneous channel state information can be used to form closed-loop. Particularly, in the one group of antenna array transmission mode, the antennas themselves of the group have formed diversity gains. Transmitting antennas of each group only need to find a half of pre-coding weights or beam weights respectively (for example, if 4 beam forming weights are needed, transmitting antennas of each group only need to find two pre-coding weights or beam weights). Therefore, power of the strongest paths can be effectively used to obtain an excellent performance.

### BRIEF DESCRIPTION OF THE DRAWINGS

FIG. 1 illustrates a schematic flow chart of a signal transmitting method according to one embodiment of the present disclosure;

FIG. 2 illustrates a schematic flow chart of a signal receiving method according to one embodiment of the present disclosure;

FIG. 3 illustrates a schematic diagram of a diversity antennas transmitting mode according to one embodiment of the present disclosure;

FIG. 4 illustrates a schematic diagram of a two groups of antenna arrays transmitting mode according to one embodiment of the present disclosure; and

FIG. 5 illustrates a BLER performance comparison diagram between the signal transmitting and receiving methods of the present disclosure and a conventional MIMO transmission method.

### DETAILED DESCRIPTION

In a transmission process of the conventional MIMO technology, BLER usually decreases slowly as SNR increases, which may affect the data transmission rate.

Space Frequency Block Code (SFBC) is another common application mode of the multi-antenna technology. The SFBC technology simultaneously transmits two different forms of two modulation symbols on two frequency points at a transmitting end, so as to improve performance by using a diversity gain resulted from uncorrelated properties of the antennas at the transmitting end.

A manner of SFBC transmitting modulation symbols is shown in Table 1. Referring to Table 1, s1 and s2 represent two modulation symbols on a data flow, −s1* represents a negative conjugated form of s1, and s2* represents a conjugated form of s2, wherein “*” represents a conjugated form of a complex-number. A SFBC coding relationship is formed by simultaneously mapping the two different forms of s1 and s2 to a first resource element 1 and a second resource element 2. In a conventional communication system, the SFBC technology is used to transmit one data flow and two modulation symbols on two resource elements, and its spectral efficiency is 1.

TABLE 1

| Physical Resources | Transmitting Port 1 | Transmitting Port 2 |
|---|---|---|
| Resource Element 1 | s1 | s2 |
| Resource Element 2 | s2* | −s1* |

Because the SFBC technology is generally used in a transmitting diversity technology and is only suitable for transmitting modulation symbols of one data flow, it is not easy for those skilled in the art to apply the SFBC technology in other technology besides the transmitting diversity technology.

However, inventors of the present disclosure consider that: if N modulation symbols can be transmitted on one resource element in MIMO, by using SFBC, 2N modulation symbols transmitted on two resource elements can be still transmitted in different forms on these two resource elements (these two resource elements may be referred as a resource element pair), so that a coding relationship of SFBC can be formed. The benefit is that, high spectral efficiency of MIMO is inherited, and transmission accuracy of MIMO is improved by using diversity gain of SFBC. Therefore, the problem of the slow decrease of BLER in the MIMO transmission is solved, the data transmission rate is improved, and transmission performance of the system is improved.

Based on the above description, a signal transmitting method and a signal receiving method, which are corresponded to each other, are provided in embodiments of the present disclosure. The signal transmitting method and the signal receiving method can be applied in an OFDM communication system. By combining the MIMO technology and the SFBC technology, P data flows of MIMO are transmitted in an SFBC mode at the transmitting end, and the receiving end receives the signals transmitted by the transmitting end and obtains modulation symbols of each data flow mapped to the resource element pair, so that performance of the MIMO transmission is improved.

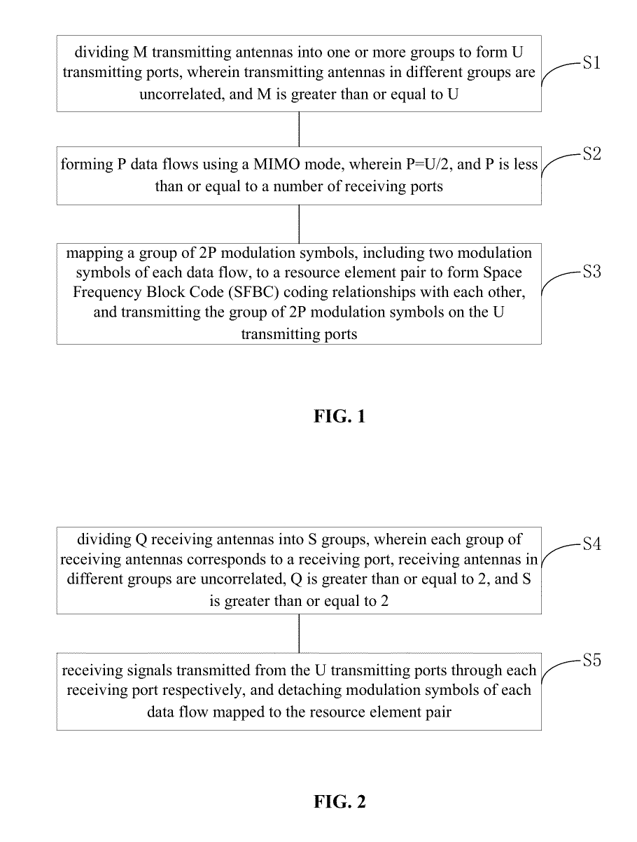

As shown in FIG. 1, the signal transmitting method of the present disclosure includes:

step S1, dividing M transmitting antennas into one or more groups to form U transmitting ports, wherein transmitting antennas in different groups are uncorrelated, and M is greater than or equal to U;

step S2, forming P data flows using a Multiple-Input Multiple-Output (MIMO) mode, wherein P=U/2, and P is less than or equal to a number of receiving ports; and

step S3, mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports.

As shown in FIG. 2, the signal receiving method of the present disclosure includes:

step S4, dividing Q receiving antennas into S groups, wherein each group of receiving antennas corresponds to a receiving port, receiving antennas in different groups are uncorrelated, Q is greater than or equal to 2, and S is greater than or equal to 2; and

step S5, receiving signals transmitted from the U transmitting ports through each receiving port respectively, and detaching modulation symbols of each data flow mapped to the resource element pair.

In some embodiments of the present disclosure, a plurality of antennas form a kind of array and jointly transmit a sequence signal based on a plurality of pre-coding weights or a plurality of beam weights. The plurality of antennas combining the weights can be referred to as a port. When a number of antennas in a port is one, this antenna can be considered as a port.

In order to clarify the objects, characteristics and advantages of the disclosure, the embodiments of the present disclosure will be described in detail in conjunction with the accompanying drawings.

In this embodiment, an OFDM communication system, particularly an LTE system, is taking as an example to describe the signal transmitting method and the signal receiving method of the present disclosure. It will be understood by those skilled in the art that the signal transmitting method and the signal receiving method can be used in other OFDM communication systems.

In this embodiment, U=4 transmitting ports, P=U/2=2 data flows and S=P=2 receiving ports are taken as an example to describe the signal transmitting method and the signal receiving method. It is feasible in theory that, U can be 6, 8, etc, and correspondingly P=U/2 can be 3, 4, etc.

An embodiment of the signal transmitting method of the present disclosure is described in detail herein.

M transmitting antennas are configured at the transmitting end, wherein M≧4. The transmitting antennas can be arranged in a variety of forms. In this embodiment, the M transmitting antennas are divided into groups in the step S1, so that all groups of transmitting antennas form four transmitting ports, and transmitting antennas in different groups are uncorrelated. It is suggested that the transmitting antennas can be arranged in three forms shown below:

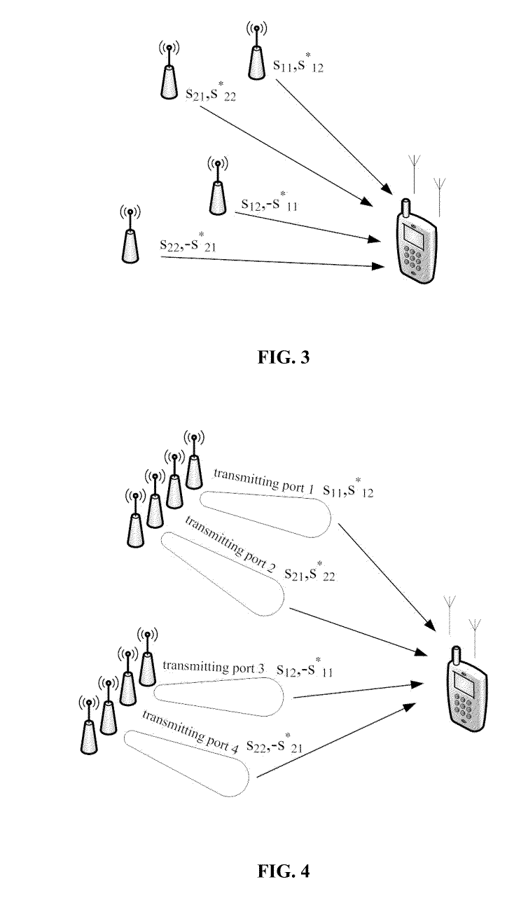

Diversity antennas: M transmitting antennas are divided into four groups. Transmitting antennas in different groups are uncorrelated. Transmitting antennas in a same group are arranged in a linear array or a circular array. It is better that the distance between two antennas is 0.5˜0.6 times of a wavelength. Four groups of transmitting antennas (corresponding to each antenna at the receiving end) form four groups of uncorrelated wireless channels. As shown in FIG. 3, a number of transmitting antennas M is four, and the four transmitting antennas are divided into four groups. Each group has one transmitting antenna. Transmitting antennas in different groups are far away from one another, and are uncorrelated.

Two groups of antenna arrays: M transmitting antennas are divided into two groups. Transmitting antennas in different groups are uncorrelated. Each group has at least two transmitting antennas. Transmitting antennas in a same group are arranged in a linear array or a circular array. It is better that the distance between two antennas is 0.5˜0.6 times of the wavelength. As shown in FIG. 4, a number of the transmitting antennas M is eight, and the eight transmitting antennas are divided into two groups. Each group has 4 transmitting antennas.

One group of antenna array: M transmitting antennas are arranged in a linear array or a circular array. It is better that a distance between two antennas is 0.5˜0.6 times of the wavelength.

In this embodiment, P data flows are formed using a MIMO mode in the step S2. P is determined by a number of the receiving ports and a number of the transmitting ports. That is, p=U/2, and P is less than or equal to the number of the receiving ports. When U=4 and the receiving end only has two receiving ports, two data flows are formed at the transmitting end.

For clarity, an MIMO having two data flows (P=2) is taken as an example. Modulation symbols to be transmitted on two resource elements are defined as s₁₁, s₁₂, s₂₁ and s₂₂. The two resource elements can be referred to as a first resource element and a second resource element respectively. The first resource element and the second resource element constitute a “resource element pair”. The modulation symbols s₁₁ and s₁₂ are data the first data flow mapped to the resource element pair. −s*₁₁ is a negative conjugated form of the modulation symbol s₁₁, and s*₁₂ is a conjugated form of s₁₂. The modulation symbols s₂₁ and s₂₂ are data the second data flow mapped to the resource element pair. −s*₂₁ is a negative conjugated form of the modulation symbol s₂₁, and s*₂₂ is a conjugated form of s₂₂.

In this embodiment, a group of 2P modulation symbols, which is constituted by two modulation symbols of each of the P data flows, are mapped to a resource element pair to form SFBC coding relationships, and the SFBC coding relationships are transmitted on the four transmitting ports in the step S3. Specifically, the modulation symbols s₁₁ and s₁₂ of the first data flow and the modulation symbols s₂₁ and s₂₂ of the second data flow are regarded as a group, and are mapped to a resource element pair to form two SFBC coding relationships.

The above three antenna arrangement forms are respectively taken as examples to describe the signal transmitting method of the present disclosure.

Referring to FIG. 3, a transmitting method of the diversity antennas includes:

dividing the M transmitting antennas into four groups to form the diversity antennas; and the step S3 including:

a first group of transmitting antennas transmitting, in a single antenna mode or a single port mode, a modulation symbol s₁₁ on a first resource element and a modulation symbol s*₁₂ on a second resource element;

a second group of transmitting antennas transmitting, in a single antenna mode or a single port mode, a modulation symbol s₂₁ on a first resource element and a modulation symbol s*₂₂ on a second resource element;

a third group of transmitting antennas transmitting, in a single antenna mode or a single port mode, a modulation symbol s₁₂ on the first resource element and a modulation symbol −s*₁₁ on the second resource element; and

a fourth group of transmitting antennas transmitting, in a single antenna mode or a single port mode, a modulation symbol s₂₂ on the first resource element and a modulation symbol −s*₂₁ on the second resource element,

wherein the single antenna mode refers to that a number of the antennas in a group is one; the single port mode refers to that a number of the antennas in a group is greater than one; and a plurality of pre-coding weights or a plurality of beam weights can be used to transmit the modulation symbols in a small array mode. Namely, if any group of transmitting antennas includes more than one transmitting antennas, antennas in different groups form diversity antennas, and the antenna in that group may transmit on the single port in an antenna array mode, where the single port is formed based on a group of pre-coding weights or beam weights.

Referring to FIG. 4, a transmitting method of the two groups of antenna arrays includes:

dividing the M transmitting antennas into two groups to form antenna arrays respectively, where each group of transmitting antennas uses two groups of pre-coding weights or beam weights to form two transmitting ports; and the step S3 including:

a transmitting port of the first group of transmitting antennas (corresponding to the transmitting port 1 in FIG. 4) transmitting a modulation symbol s₁₁ on a first resource element, and transmitting a modulation symbol s*₁₂ on a second resource element, and the other transmitting port of the first group of transmitting antennas (corresponding to the transmitting port 2 in FIG. 4) transmitting a modulation symbol s₂₁ on the first resource element, and transmitting a modulation symbol s*₂₂ on the second resource element; and

a transmitting port of the second group of transmitting antennas (corresponding to the transmitting port 3 in FIG. 4) transmitting a modulation symbol s₁₂ on the first resource element, and transmits the modulation symbol −s*₁₁ on the second resource element, and the other transmitting port of the second group of transmitting antennas (corresponding to the transmitting port 4 in FIG. 4) transmitting a modulation symbol s₂₂ on the first resource element, and transmits a modulation symbol −s*₂₁ on the second resource element;

A transmitting method of the one group of antenna array includes:

dividing the M transmitting antennas to form one group of transmitting antennas which constitute an antenna array, where the antenna array forms four transmitting ports based on four groups of pre-coding weights or beam weights; and the step S3 including:

a first transmitting port transmitting a modulation symbol s₁₁ on a first resource element, and transmitting a modulation symbol s*₁₂ on a second resource element;

a second transmitting port transmitting a modulation symbol s₂₁ on the first resource element, and transmitting a modulation symbol s*₂₂ on the second resource element;

a third transmitting port transmitting a modulation symbol s₁₂ on the first resource element, and transmitting a modulation symbol −s*₁₁ on the second resource element; and

a fourth transmitting port transmitting a modulation symbol s₂₂ on the first resource element, and transmitting a modulation symbol −s*₂₁ on the second resource element,

It should be noted that, in an actual implementation, the transmitting end usually arranges multi-antennas to form an array in order to improve performance, and transmits in a beam-forming manner to improve data transmitting accuracy. In this embodiment, when the above three antenna arrangement modes are used to transmit signals at the transmitting end, each group of transmitting antennas constituting the antenna array form a plurality of transmitting ports based on pre-coding weights or beam weights. A number of the pre-coding weights or the beam weights is equal to a number of the transmitting ports.

In a specific implementation, the pre-coding weights or the beam weights are obtained based on a codebook, an estimation of uplink channels, or other ways. A method for obtaining the pre-coding weights or the beam weights based on an estimation of uplink channels includes: performing a channel estimation in frequency domain based on a pilot signal transmitted from an receiving end; converting a result of the channel estimation into time domain and estimating Direction Of Arrival (DOA) values of a plurality of resolvable paths in time domain; selecting DOA values corresponding to R strongest paths for each group of transmitting antennas and generating corresponding direction vectors as the pre-coding weights or the beam weights, wherein R is determined by a number of the groups of the transmitting antennas.

It should be noted that, a method combining the MIMO technology and the SFBC technology is disclosed in the prior art. The method listed possible combinations of Spatial Multiplexing (SM) and SFBC, and disclosed specific combinations of various antenna configurations. The system has two kinds of operation modes, open-loop and closed-loop. Fixed beam-forming is used for transmitting in the open-loop, and by using Channel State Information (CSI), Singular Value Decomposition (SVD) beams (decomposing singular values of channel matrix, and selecting feature vectors corresponding to larger singular values to form beams) are used for transmitting in the closed-loop. The CSI is feedback from the receiving end or is obtained from channel interaction at the transmitting end. In the open-loop mode, if a number of the transmitting antennas is configured to be four and a number of the receiving antennas is configured to be two, the rank of the channel matrix can only be two which is limited by the dimension of the channel matrix. A number of effective SVD beams can only be two, so that a combination of two SFBC is not supported.

The signal transmitting method of the present disclosure supports various transmitting mode including the diversity antennas transmitting mode, two groups of antenna arrays transmitting mode, one group of antenna array transmitting mode, etc. In the diversity antennas transmitting mode and the one group of antenna array transmitting mode, not only the fixed beam-forming transmission of the open-loop, but also the closed-loop is supported, namely, the beam transmission using CSI is supported. The method of the present disclosure solves the problem that the beam-forming is not enough because of a limitation of a number of the receiving antennas in the closed-loop mode. In the method of the present disclosure, by using symmetry of the uplink channels and the downlink channels, the transmitting end uses pilot signals to perform channel estimation in frequency domain, converts a channel estimation sequence into time domain, estimates DOA values of a plurality of resolvable paths in time domain by using a Multiple Signal Classification (MUSIC) method, an Estimation of Signal Parameters Via Rotational Invariance Techniques (ESPRIT) method, or other method, selects DOA values corresponding to R strongest paths for each group of transmitting antennas, and generates a plurality of direction vectors as beam-forming (namely, beam weights) for transmitting, wherein R is determined by a number of the groups of the transmitting antennas.

For example, a number of the transmitting antennas is configured to be four and a number of the receiving antennas is configured to be two. If the transmitting end uses the two groups of antenna arrays transmitting mode, each group respectively estimates DOA values in time domain, selects two DOA values corresponding to two strongest paths, and generates direction vectors as beam-forming for transmitting. If the transmitting end uses the one group of antenna array transmitting mode, the group estimates DOA values in time domain, selects DOA values corresponding to four strongest paths, and generates direction vectors as beam forming for transmitting.

By dividing the M transmitting antennas to form two groups of antenna arrays or one group of antenna array for beam-forming transmission, the demodulation performance of the MIMO+SFBC manner is improved because instantaneous channel state information can be used to form closed-loop. Particularly, in the one group of antenna array transmission mode, the antennas themselves of the group have formed diversity gains. Transmitting antennas of each group only need to find a half of pre-coding weights or beam weights respectively (for example, if 4 beam forming weights are needed, transmitting antennas of each group only need to find two pre-coding weights or beam weights). Therefore, power of the strongest paths can be effectively used to obtain an excellent performance.

In addition, the signal transmitting method of the present disclosure further includes: allocating U pilot signals configured by the system to the U transmitting ports respectively. Specifically, the system allocates four resource elements for transmitting pilot signals, and the four resource elements correspond to four transmitting ports, so that two antennas at the receiving end can estimate 2×4 channel values.

Corresponding to the above signal transmitting method, a signal transmitting device is provided in embodiments of the present disclosure. The device may include: a first grouping unit, adapted for dividing M transmitting antennas into one or more groups to form U transmitting ports, wherein transmitting antennas in different groups are uncorrelated, and M is greater than or equal to U; a MIMO unit, adapted for f forming P data flows using a MIMO mode, wherein P=U/2, and P is less than or equal to a number of receiving ports; and a mapping unit, adapted for mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports.

In a specific implementation, the grouping unit divides M transmitting antennas into a plurality of groups, and the one or more groups of transmitting antennas constitute diversity antennas, one group or more than one group of antenna arrays. In this embodiment, each group of transmitting antennas constituting the antenna array forms a plurality of transmitting ports based on a plurality of pre-coding weights or a plurality of beam weights, and a number of the pre-coding weights or a number of the beam weights is equal to a number of the transmitting ports.

In this embodiment, the signal transmitting device further includes an obtaining unit, adapted for obtaining the pre-coding weights or the beam weights based on a codebook or an estimation of uplink channels. In a specific implementation, the obtaining unit includes: a first estimating unit, adapted for performing channel estimation in frequency domain based on a pilot signal transmitted from an receiving end; a second estimating unit, adapted for converting a result of the channel estimation into time domain and estimating Direction Of Arrival (DOA) values of a plurality of resolvable paths in time domain; a generating unit, adapted for selecting DOA values corresponding to R strongest paths for each group of transmitting antennas and generating corresponding direction vectors as the pre-coding weights or the beam weights, wherein R is determined by a number of the groups of the transmitting antennas.

In addition, the signal transmitting device further includes an allocating unit, adapted for allocating U pilot signals configured by the system to the U transmitting ports respectively. When U=4, the allocating unit allocates four pilot signals configured by the system to the four transmitting ports respectively.

The implementation of the signal transmitting device is referred to the signal transmitting method in embodiments of the present disclosure, and is not described herein.

A signal receiving method is provided in embodiments of the present disclosure. The signal receiving method may include: configuring Q receiving antennas at the receiving end, wherein Q≧2; dividing Q receiving antennas into S groups in step S4, wherein S is greater than or equal to 2, each group of receiving antennas corresponds to a receiving port, receiving antennas in different groups are configured to be uncorrelated (a distance between two antennas is large enough, or antennas are cross polarization, or other modes). The minimum configuration of the receiving end is two receiving antennas, so that the two receiving antennas can be divided into two groups, and each group includes one receiving antenna. If a number of the receiving antennas is greater than two, the antennas can be divided into S groups, each group includes more than one receiving antenna, and antennas in different groups are uncorrelated.

Hereunder, the minimum configuration of the receiving end is taken as an example to describe the signal receiving method of the present disclosure in detail.

In this embodiment, signals transmitted from the transmitting ports are received at each receiving port respectively, and modulation symbols of each data flow mapped to the resource element pair are detached.

Specifically, detaching modulation symbols of each data flow mapped to the resource element pair in step S5 may include: obtaining channel estimation values of pilot signals transmitted from the four transmitting ports and received at each receiving port; forming a combined transmission equation based on the channel estimation values and the received modulation symbols mapped to the resource element pair; and solving the combined transmission equation to detach each modulation symbol.

For clarity, a plurality of symbols are defined as below.

The pre-coding weights or beam weights transmitted from the four transmitting ports are Wᵢⱼ, wherein i=1, 2 represents a transmitting port number of the j^{th} data flow, j=1, 2 represents a sequence number of the data flow. A number of the elements Wᵢⱼ represents a number of the antennas in a group. For the diversity antennas transmission mode, if the number of antennas in a group is one, Wᵢⱼ=1.

Fading channels, through which the signal transmitted from the four transmitting ports passed to the receiving antennas, are h_{xy}, wherein x=1, 2 corresponds to a receiving port number, and y=1, 2, 3, 4 corresponds to a transmitting port number.

Signals the two receiving antennas received on the two resource elements are defined as r_{pq}, wherein p=1, 2 represents a receiving port number, and q=1, 2 represents resource an element number.

Then, the signals the two receiving antennas received on the two resource elements are represented by:

r₁₁=w₁₁h₁₁s₁₁+w₁₂h₁₂s₂₁+w₂₁h₁₃s₁₂+w₂₂h₁₄s₂₂ (1)

r₁₂=w₁₁h₁₁s*₁₂+w₁₂h₁₂s*₂₂−w₂₁h₁₃s*₁₁−w₂₂h₁₄s*₂₁ (2)

r₂₁=w₁₁h₂₁s₁₁+w₁₂h₂₂s₂₁+w₂₁h₂₃s₁₂+w₂₂h₂₄s₂₂ (3)

r₂₂=w₁₁h₂₁s*₁₂+w₁₂h₂₂s*₂₂−w₂₁h₂₃s*₁₁−w₂₂h₂₄s*₂₁ (4)

Channel values estimated at the receiving end are described hereunder.

\tilde{h}₁₁, \tilde{h}₁₂, \tilde{h}₁₃, \tilde{h}₁₄ respectively corresponds to estimated channel values of pilot signals transmitted from the four transmitting ports and received at the first receiving antenna. Relationships between these estimated channel values, the pre-coding weights or beam weights of the transmitting end, and fading channels the signals passed through are represented by: \tilde{h}₁₁=W₁₁h₁₁, \tilde{h}₁₂=W₁₂h₁₂, \tilde{h}₁₃=W₂₁h₁₃, \tilde{h}₁₄=W₂₂h₁₄.

\tilde{h}₂₁, \tilde{h}₂₂, \tilde{h}₂₃, \tilde{h}₂₄ respectively corresponds to estimated channel values of pilot signals transmitted from the four transmitting ports and received at the second receiving antenna. Relationships between these estimated channel value, the pre-coding weights or beam weights of the transmitting end, and fading channels the signals passed through are represented by: \tilde{h}₂₁=W₁₁h₂₁, \tilde{h}₂₂=W₁₂h₂₂, \tilde{h}₂₃=W₂₁h₂₃, \tilde{h}₂₄=W₂₂h₂₄.

Then, the signals the two receiving antennas received on the two resource elements can be represented by:

r₁₁=\tilde{h}₁₁s₁₁+\tilde{h}₁₂s₂₁+\tilde{h}₁₃s₁₂+\tilde{h}₁₄s₂₂ (5)

r₁₂=\tilde{h}₁₁s*₁₂+\tilde{h}₁₂s*₂₂−\tilde{h}₁₃s*₁₁−\tilde{h}₁₄s*₂₁ (6)

r₂₁=\tilde{h}₂₁s₁₁+\tilde{h}₂₂s₂₁+\tilde{h}₂₃s₁₂+\tilde{h}₂₄s₂₂ (7)

r₂₂=\tilde{h}₂₁s*₁₂+\tilde{h}₂₂s*₂₂−\tilde{h}₂₃s*₁₁−\tilde{h}₂₄s*₂₁ (8).

Combined transmission equation, formed by the channel estimated values and the modulation symbols mapped to the resource element pair, can be represented by:

$$[ \begin{matrix}{r}_{11} \\ {r}_{12}^{*} \\ {r}_{21} \\ {r}_{22}^{*}\end{matrix} ] = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] [ \begin{matrix}{s}_{11} \\ {s}_{12} \\ {s}_{21} \\ {s}_{22}\end{matrix} ] \qquad ( 9 )$$

and let:

$$H = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] \qquad ( 10 )$$

It can be seen that, H in Equation (10) is a 4-dimensional matrix. Therefore, the four modulation symbols, mapped to the resource element pair using two SFBC, can be resolved.

In this embodiment, a Minimum Mean Square Error (MMSE) estimation method is used to solve the combined transmission equation through the following equation, so as to obtain each of the modulation symbols.

$$[ \begin{matrix}{\hat{s}}_{11} \\ {\hat{s}}_{12} \\ {\hat{s}}_{21} \\ {\hat{s}}_{22}\end{matrix} ] = {( {H}^{H} H + {R}_{n} )}^{- 1} {H}^{H} [ \begin{matrix}{r}_{11} \\ {r}_{12}^{*} \\ {r}_{21} \\ {r}_{22}^{*}\end{matrix} ] \qquad ( 11 )$$

wherein, ŝ₁₁, ŝ₁₂, ŝ₂₁ and ŝ₂₂ represent resolved modulation symbols, and Rₙ is a matrix related to noise estimation. The noise estimation is known to those skilled in the art, and is not described in detail herein. In other embodiments, other methods (for example, least squares estimation method) can be used to solve the equation to obtain the modulation symbols.

Corresponding to the signal receiving method, a signal receiving system is also provided in embodiments of the present disclosure. The system may include: a second grouping unit, adapted for dividing Q receiving antennas into S groups, wherein each group of receiving antennas corresponds to a receiving port, receiving antennas in different groups are uncorrelated, Q is greater than or equal to 2, and S is greater than or equal to 2; a receiving unit, adapted for receiving signals transmitted by the signal transmitting device according to any one of claims 12 to 17 through each receiving port; and a detaching unit, adapted for detaching modulation symbols of each data flow mapped to the resource element pair.

In this embodiments, Q=2, and S=2 are taken as an example to describe the signal receiving system.

In a specific implementation, the detaching unit includes: an acquisition unit, adapted for obtaining channel estimation values of pilot signals transmitted from the four transmitting ports and received at the receiving ports; a forming unit, adapted for forming a combined transmission equation based on the channel estimation values and the received modulation symbols mapped to the resource element pair; and a solving unit, adapted for solving the combined transmission equation to detach each of the modulation symbols.

The implementation of the signal receiving device is referred to the signal receiving method of the present disclosure, and is not described in detail herein.

In addition, an OFDM communication system is provided in embodiments of the present disclosure. The ODM communication system includes the above signal transmitting device and the above signal receiving device.

The OFDM communication system of the present disclosure is described in two implementations hereunder.

In a specific implementation, the OFDM communication system uses the signal transmitting device and the signal receiving device shown in FIG. 3. Four transmitting antennas at the transmitting side are disposed in different positions respectively, so that channels between antennas are completely uncorrelated. Assuming a user terminal A is a receiving end, two receiving antennas are configured at the user terminal A for cost consideration, and the two receiving antennas are disposed in a cross polarization mode.

Two data flow sequences the system allocates to the user terminal A are: s₁₁, s₁₂, s₁₃, s₁₄, . . . s_{1N}, and s₂₁, s₂₂, s₂₃, s₂₄, . . . s_{2N}. The system allocates N resource elements to the user terminal A, where N is a multiple of two, and every two resource elements are defined as a resource element pair. For example, s₁₁, s₁₂ and s₂₁, s₂₂ as a group are mapped to a resource element pair, s₁₃, s₁₄ and s₂₃, s₂₄ as a group are mapped to a resource element pair, and so on until all the modulation symbols are mapped.

Modulation symbols to be transmitted at the transmitting end are divided into groups to form an SFBC mode for transmitting, wherein each of the groups includes two modulation symbols of every data flow, altogether four modulation symbols, and the pre-coding weight of each transmitting antenna is one. Then, the modulation symbols are transmitted using a method shown in FIG. 3. The detail of the method can refer to the above diversity antennas transmission method. Meanwhile, using every transmitting antenna, the transmitting end transmits pilot signals on four pilot positions defined by the system.

The user terminal A sequentially processes received signals which have every two resource elements as a pair. The k^{th} pair of received signals is processed as below:

based on pilot signals arranged by the system, the user terminal A estimating a 2×4 channel value:

$$[ \begin{matrix}{\tilde{h}}_{11} , & {\tilde{h}}_{12} , & {\tilde{h}}_{13} , & {\tilde{h}}_{14} \\ {\tilde{h}}_{21} , & {\tilde{h}}_{22} , & {\tilde{h}}_{23} , & {\tilde{h}}_{24}\end{matrix} ] ;$$

the user terminal A constructing a transmission matrix H as shown in Equation (10) based on the estimated channel values; and

the User terminal A solving the estimating values of the transmitted signals according to a method shown in Equation (11), namely, detaching the modulation symbols.

In another embodiment, the OFDM communication system uses the signal transmitting device and the signal receiving device shown in FIG. 4. Eight transmitting antennas at the transmitting end are divided into two groups. Transmitting antennas in a group are arranged in a linear array. The distance between two antennas is 0.5˜0.6 times of the wavelength. Assuming a user terminal B is a receiving end, two receiving antennas are configured at the user terminal A for cost consideration, and the two receiving antennas are disposed in a cross polarization mode.

Two data flow sequences the system allocates to the user terminal B are: s₁₁, s₁₂, s₁₃, s₁₄, . . . s_{1N}, and s₂₁, s₂₂, s₂₃, s₂₄, . . . s_{2N}. The system allocates N resource elements to the user terminal B, where N is a multiple of two, and every two resource elements are defined as a resource element pair.

Modulation symbols to be transmitted at the transmitting end are divided into groups to form an SFBC mode for transmitting, wherein each of the groups includes two modulation symbols of every data flow, altogether four modulation symbols.

Each group of antennas at the transmitting end forms two transmitting ports using two groups of pre-coding weights or beam weights (the weights can be obtained based on a codebook, an estimation of uplink channels, or other ways). Then, the modulation symbols are transmitted using a method shown in FIG. 4. The detail of the method can refer to the above two groups of antenna arrays transmission method. Meanwhile, using every transmitting antenna, the transmitting end transmits pilot signals on four pilot positions defined by the system.

The user terminal B sequentially processes received signals which have every two resource elements as a pair. The k^{th} pair of received signals is processed as below:

based on pilot signals arranged by the system, the user terminal B estimates a 2×4 channel value:

$$[ \begin{matrix}{\tilde{h}}_{11} , & {\tilde{h}}_{12} , & {\tilde{h}}_{13} , & {\tilde{h}}_{14} \\ {\tilde{h}}_{21} , & {\tilde{h}}_{22} , & {\tilde{h}}_{23} , & {\tilde{h}}_{24}\end{matrix} ] ;$$

the user terminal B constructing a transmission matrix H as shown in Equation (10) based on the estimated channel value; and

the User terminal B solving estimating values of the transmitted signals according to a method shown in Equation (11), namely, detaching the modulation symbols.

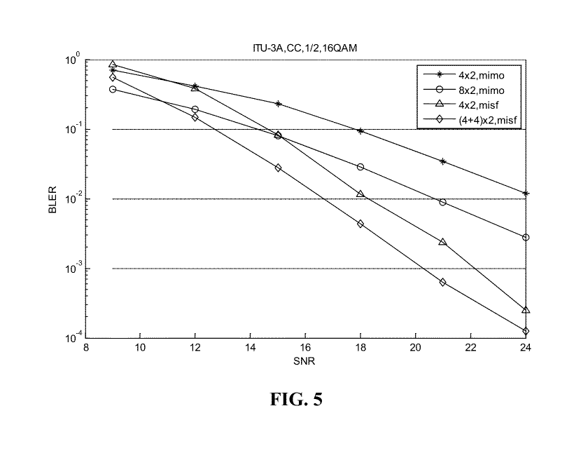

A BLER performance comparison between the signal transmitting and receiving method of the present disclosure and a conventional MIMO transmission is illustrated in FIG. 5. As shown in FIG. 5, “ITU-3A,CC,½,16QAM” indicates that the relevant performance curves are obtained by a simulation on an ITU-3A channel, convolution coding and ½ coding rate are adopted, and modulation mode is 16QAM. “4×2,mimo” and “8×2,mimo” correspond to BLER curves which only use MIMO transmission. “4×2,misf” and “(4+4)×2,misf” correspond to BLER curves which used the transmission technology of the present disclosure combining MIMO and SFBC. It can be seen from FIG. 5, compared with the technology only using MIMO, the BLER curve of the technology combining MIMO and SFBC decreases faster as SNR increases.

The signal transmitting method and device, and the signal receiving method and device have following advantages. If the user terminal only configured with two receiving antennas for cost reasons, MIMO transmission may be adapted when surrounding transmission environments is good. However, MIMO can only transmit two data flow by a limitation of antenna number, and the two data flow transmitted by MIMO may form a mutual interference. Therefore, BLER is great and decreases slowly as SNR increases, which affects the data transmission rate. If the scheme of the present disclosure is used, these problems can be significant improved, and a high transmission rate can be achieved without increasing costs.

It will be apparent to those skilled in the art that some or all of the signal transmitting device and the signal receiving device provided in embodiments of the present disclosure may be performed by some programs in response to common hardware. The program may be stored in a computer-readable storage medium. The storage medium may be a Read-Only Memory (ROM), a Random Access Memory (RAM), a magnetic disk, or an optical disk, etc.

Although the present disclosure has been disclosed above with reference to preferred embodiments thereof, it should be understood by those skilled in the art that various changes may be made without departing from the spirit or scope of the disclosure. Accordingly, the present disclosure is not limited to the embodiments disclosed.

1.-3. (canceled)

4. A signal transmitting method for Orthogonal Frequency Division Multiplexing (OFDM) communication system, comprising:
dividing M transmitting antennas into one or more groups to form U transmitting ports, wherein transmitting antennas in different groups are uncorrelated, and M is greater than or equal to U;
forming P data flows using a Multiple-Input Multiple-Output (MIMO) mode, wherein P=U/2, and P is less than or equal to a number of receiving ports; and
mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports,
wherein the one or more groups of transmitting antennas formed by dividing the M transmitting antennas constitute diversity antennas, one group or more than one group of antenna arrays;
wherein each group of transmitting antennas constitutes an antenna array, and forms one or more transmitting ports based on one or more pre-coding weights or one or more beam weights, where the number of the pre-coding weights or the number of the beam weights is equal to the number of the transmitting ports;
wherein U=4, P=2, the M transmitting antennas are divided into four groups, and the four groups of transmitting antennas constitute diversity antennas; and
wherein mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports comprise:
a first group of transmitting antennas transmitting, in a single antenna mode or a single port mode, a modulation symbol s₁₁ on a first resource element and a modulation symbol s*₁₂ on a second resource element;
a second group of transmitting antennas transmitting, in a single antenna mode or a single port mode, a modulation symbol s₂₁ on a first resource element and a modulation symbol s*₂₂ on a second resource element;
a third group of transmitting antennas transmitting, in a single antenna mode or a single port mode, a modulation symbol s₁₂ on the first resource element and a modulation symbol −s*₁₁ on the second resource element; and
a fourth group of transmitting antennas transmitting, in a single antenna mode or a single port mode, a modulation symbol s₂₂ on the first resource element and a modulation symbol −s*₂₁ on the second resource element,
wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

5. The signal transmitting method according to claim 4, wherein if any group of transmitting antennas comprises more than one transmitting antennas, the transmitting antennas in that group form a single port based on one group of pre-coding weights or beam weights and transmit in an antenna array mode.

6. A signal transmitting method for Orthogonal Frequency Division Multiplexing (OFDM) communication system, comprising:
dividing M transmitting antennas into one or more groups to form U transmitting ports, wherein transmitting antennas in different groups are uncorrelated, and M is greater than or equal to U;
forming P data flows using a Multiple-Input Multiple-Output (MIMO) mode, wherein P=U/2, and P is less than or equal to a number of receiving ports; and
mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports,
wherein the one or more groups of transmitting antennas formed by dividing the M transmitting antennas constitute diversity antennas, one group or more than one group of antenna arrays;
wherein each group of transmitting antennas constitutes an antenna array, and forms one or more transmitting ports based on one or more pre-coding weights or one or more beam weights, where the number of the pre-coding weights or the number of the beam weights is equal to the number of the transmitting ports;
wherein U=4, P=2, the M transmitting antennas are divided into two groups to form antenna arrays respectively, and each group of transmitting antennas uses two groups of pre-coding weights or beam weights to form two transmitting ports; and
wherein mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports comprise:
the first group of transmitting antennas using a first transmitting port thereof to transmit a modulation symbol s₁₁ on a first resource element, and transmit a modulation symbol s*₁₂ on a second resource element, and the first group of transmitting antennas using a second transmitting port thereof to transmit a modulation symbol s₂₁ on the first resource element, and transmit a modulation symbol s*₂₂ on the second resource element; and
the second group of transmitting antennas using a first transmitting port thereof to transmit a modulation symbol s₁₂ on the first resource element, and transmit the modulation symbol −s*₁₁ on the second resource element, and the second group of transmitting antennas using a second transmitting port thereof to transmit a modulation symbol s₂₂ on the first resource element, and transmit a modulation symbol −s*₂₁ on the second resource element,
wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

7. A signal transmitting method for Orthogonal Frequency Division Multiplexing (OFDM) communication system, comprising:
dividing M transmitting antennas into one or more groups to form U transmitting ports, wherein transmitting antennas in different groups are uncorrelated, and M is greater than or equal to U;
forming P data flows using a Multiple-Input Multiple-Output (MIMO) mode, wherein P=U/2, and P is less than or equal to a number of receiving ports; and
mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports,
wherein the one or more groups of transmitting antennas formed by dividing the M transmitting antennas constitute diversity antennas, one group or more than one group of antenna arrays;
wherein each group of transmitting antennas constitutes an antenna array, and forms one or more transmitting ports based on one or more pre-coding weights or one or more beam weights, where the number of the pre-coding weights or the number of the beam weights is equal to the number of the transmitting ports;
wherein U=4, P=2, the M transmitting antennas are divided to form one group of transmitting antennas which constitute an antenna array, and the antenna array forms four transmitting ports based on four groups of pre-coding weights or beam weights; and
wherein mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports comprise:
a first transmitting port transmitting a modulation symbol s₁₁ on a first resource element, and transmitting a modulation symbol s*₁₂ on a second resource element;
a second transmitting port transmitting a modulation symbol s₂₁ on the first resource element, and transmitting a modulation symbol s*₂₂ on the second resource element;
a third transmitting port transmitting a modulation symbol s₁₂ on the first resource element, and transmitting a modulation symbol −s*₁₁ on the second resource element; and
a fourth transmitting port transmitting a modulation symbol s₂₂ on the first resource element, and transmitting a modulation symbol −s*₂₁ on the second resource element,
wherein the first resource element and the second resource element are two resource elements of the resource element pair, the modulation symbols s₁₁ and s₁₂ are data of a first data flow, the modulation symbol −s*₁₁ is a negative conjugated form of the modulation symbol s₁₁, the modulation symbol s*₁₂ is a conjugated form of the modulation symbol s₁₂, the modulation symbols s₂₁ and s₂₂ are data of a second data flow, the modulation symbol −s*₂₁ is a negative conjugated form of the modulation symbol s₂₁, and the modulation symbol s*₂₂ is a conjugated form of the modulation symbol s₂₂.

8.-19. (canceled)

20. A signal receiving method for Orthogonal Frequency Division Multiplexing (OFDM) communication system, comprising:
dividing Q receiving antennas into S groups, wherein each group of receiving antennas corresponds to a receiving port, receiving antennas in different groups are uncorrelated, Q is greater than or equal to 2, and S is greater than or equal to 2; and
receiving signals transmitted by a signal transmitting method through each receiving port, and detaching modulation symbols of each data flow mapped to the resource element pair, wherein the signal transmitting method comprises: dividing M transmitting antennas into one or more groups to form U transmitting ports, wherein transmitting antennas in different groups are uncorrelated, and M is greater than or equal to U; forming P data flows using a Multiple-Input Multiple-Output (MIMO) mode, wherein P=U/2, and P is less than or equal to a number of receiving ports; and mapping a group of 2P modulation symbols, including two modulation symbols of each data flow, to a resource element pair to form Space Frequency Block Code (SFBC) coding relationships with each other, and transmitting the group of 2P modulation symbols on the U transmitting ports;
wherein detaching modulation symbols of each data flow mapped to the resource element pair comprises:
obtaining channel estimation values of pilot signals transmitted from the U transmitting ports and received at each receiving port;
forming a combined transmission equation based on the channel estimation values and the received modulation symbols mapped to the resource element pair; and
solving the combined transmission equation to detach each modulation symbol;
wherein U=4, and S=2;
wherein signals r_{pq} the two receiving antennas received on the resource element pair are represented by:
r₁₁=w₁₁h₁₁s₁₁+w₁₂h₁₂s₂₁+w₂₁h₁₃s₁₂+w₂₂h₁₄s₂₂;
r₁₂=w₁₁h₁₁s*₁₂+w₁₂h₁₂s*₂₂−w₂₁h₁₃s*₁₁−w₂₂h₁₄s*₂₁;
r₂₁=w₁₁h₂₁s₁₁+w₁₂h₂₂s₂₁+w₂₁h₂₃s₁₂+w₂₂h₂₄s₂₂;
r₂₂=w₁₁h₂₁s*₁₂+w₁₂h₂₂s*₂₂−w₂₁h₂₃s*₁₁−w₂₂h₂₄s*₂₁;
wherein p=1, 2 represents receiving port number, and q=1, 2 represents resource element number;
wherein s₁₁, s₁₂, s₂₁ and s₂₂ are modulation symbols of each data flow mapped to the resource element pair, the modulation symbol −s*₁₁ is a negative conjugated form of the modulation symbol s₁₁, the modulation symbol s*₁₂ is a conjugated form of the modulation symbol s₁₂, the modulation symbol −s*₂₁ is a negative conjugated form of the modulation symbol s₂₁, and the modulation symbol s*₂₂ is a conjugated form of the modulation symbol s₂₂;
wherein \tilde{h}₁₁, \tilde{h}₁₂, \tilde{h}₁₃, \tilde{h}₁₄ represent channel estimation values of pilot signals transmitted from the four transmitting ports and received at the first receiving antenna, where \tilde{h}₁₁=W₁₁h₁₁, \tilde{h}₁₂=W₁₂h₁₂, \tilde{h}₁₃=W₂₁h₁₃, \tilde{h}₁₄=W₂₂h₁₄;
wherein \tilde{h}₂₁, \tilde{h}₂₂, \tilde{h}₂₃, \tilde{h}₂₄ represent channel estimation values of pilot signals transmitted from the four transmitting ports and received at the second receiving antenna, where \tilde{h}₁₂=W₁₁h₂₁, \tilde{h}₂₂=W₁₂h₂₂, \tilde{h}₂₃=W₂₁h₂₃, \tilde{h}₂₄=W₂₂h₂₄;
wherein Wᵢⱼ represents the transmission pre-coding weights or beam weights of the four transmitting ports, where i=1, 2 represents a transmitting port number of the j^{th} data flow, j=1, 2 represents a sequence number of the data flow, h_{xy} represents fading channels of signals transmitted from the four transmitting ports to the receiving ports, x=1, 2 corresponds to a receiving port number, and y=1, 2, 3, 4 corresponds to a transmitting port number; and
wherein the combined transmission equation is represented by:
$$[ \begin{matrix}{r}_{11} \\ {r}_{12}^{*} \\ {r}_{21} \\ {r}_{22}^{*}\end{matrix} ] = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] [ \begin{matrix}{s}_{11} \\ {s}_{12} \\ {s}_{21} \\ {s}_{22}\end{matrix} ] .$$

21. The signal receiving method according to claim 20, wherein a Minimum Mean Square Error (MMSE) estimation method is used to solve the combined transmission equation through an equation shown below, so as to obtain each modulation symbol:
$$[ \begin{matrix}{\hat{s}}_{11} \\ {\hat{s}}_{12} \\ {\hat{s}}_{21} \\ {\hat{s}}_{22}\end{matrix} ] = {( {H}^{H} H + {R}_{n} )}^{- 1} {H}^{H} [ \begin{matrix}{r}_{11} \\ {r}_{12}^{*} \\ {r}_{21} \\ {r}_{22}^{*}\end{matrix} ] ;$$
where ŝ₁₁, ŝ₁₂, ŝ₂₁ and ŝ₂₂ represent resolved modulation symbols, Rₙ is a matrix related to noise estimation, and
$$H = [ \begin{matrix}{\tilde{h}}_{11} & {\tilde{h}}_{13} & {\tilde{h}}_{12} & {\tilde{h}}_{14} \\ - {\tilde{h}}_{13}^{*} & {\tilde{h}}_{11}^{*} & - {\tilde{h}}_{14}^{*} & {\tilde{h}}_{12}^{*} \\ {\tilde{h}}_{21} & {\tilde{h}}_{23} & {\tilde{h}}_{22} & {\tilde{h}}_{24} \\ - {\tilde{h}}_{23}^{*} & {\tilde{h}}_{21}^{*} & - {\tilde{h}}_{24}^{*} & {\tilde{h}}_{22}^{*}\end{matrix} ] .$$

22.-24. (canceled)
